(19) United States
(12) Patent Application Publication
(10) Pub. No.: US 2026/0247170 A1
(43) Pub. Date: Aug. 20, 2026

(54) ERROR-FREE TRANSMISSIONS IN AVM C-V2X-BASED WIRELESS NETWORKS

(71) Applicant: Ford Global Technologies, LLC, Dearborn, MI (US)

(72) Inventors: Ivan Vukovic, Birmingham, MI (US); Krishna Bandi, Novi, MI (US); Syed Amaar Ahmad, Canton, MI (US)

(21) Appl. No.: 19/053,536

(22) Filed: Feb. 14, 2025

(51) Int. Cl. H04W 24/02; H04W 4/40; H04W 16/04; H04W 72/11

(52) U.S. Cl. CPC H04W 24/02; H04W 4/40; H04W 16/04; H04W 72/11

(57) ABSTRACT

Partitioning transmit resources in an automated vehicle marshaling (AVM) system includes identifying a plurality of road-side units (RSUs) of the AVM system, the RSUs configured to communicate with a plurality of vehicles; assigning each RSU of the plurality of RSUs to a non-overlapping RSU transmit (Tx) pool for semi-persistent scheduling (SPS) such that none of the RSUs share a common transmission slot within a SPS transmission schedule with another RSU or with any of the vehicles; assigning a common vehicle Tx pool for the vehicles, wherein the vehicles are restricted to transmit within the common vehicle Tx pool to prevent overlapping transmissions with the RSU Tx pools; transmitting, by each of the plurality of RSUs, vehicle control messages using the assigned RSU Tx pool to prevent overlap with transmissions from the other RSUs and/or with the vehicles.

### TECHNICAL FIELD

Aspects of the disclosure generally relate to error-free transmissions in automated vehicle marshaling (AVM) cellular vehicle to everything (C-V2X)-based wireless networks.

### BACKGROUND

Vehicle-to-everything (V2X) is a type of communication that allows vehicles to communicate with various aspects of the traffic environment. This communication may include interacting with vehicles using vehicle-to-vehicle (V2V) communication and interacting with infrastructure using vehicle-to-infrastructure (V2I) communication.

Vehicles may include radio transceivers and vehicle on-board units (OBUs) to facilitate V2X communications. Road-side units (RSUs) may provide wireless communications from roadside infrastructure to the OBUs. Such communication may be referred to as infrastructure-to-vehicle (I2V) communication. RSUs generally operate in the same frequency band as V2X, over technologies such as Cellular Vehicle-to-Everything (CV2X) and Dedicated Short Range Communications (DSRC) technologies. Some RSUs provide additional functionality, such as local Wi-Fi hotspots for pedestrians, cellular backhaul to communicate information with a central system or direct communication and localization using Bluetooth and Ultra-wideband (UWB) technology.

### SUMMARY

In one or more illustrative examples, a method for partitioning transmit resources in an automated vehicle marshaling (AVM) system includes identifying a plurality of road-side units (RSUs) of the AVM system, the RSUs configured to communicate with a plurality of vehicles; assigning each RSU of the plurality of RSUs to a non-overlapping RSU transmit (Tx) pool for scheduling such that none of the RSUs share a common transmission slot within a transmission schedule with another RSU or with any of the vehicles; assigning a common vehicle Tx pool for the vehicles, wherein the vehicles are restricted to transmit within the common vehicle Tx pool to prevent overlapping transmissions with the RSU Tx pools; transmitting, by each of the plurality of RSUs, vehicle control messages using the assigned RSU Tx pool to prevent overlap with transmissions from the other RSUs and/or with the vehicles.

In one or more illustrative examples, the scheduling is semi-persistent scheduling (SPS) and assigning the plurality of Tx pools comprises defining a repeating pattern of time transmission intervals (TTIs) for each of a plurality of different transmission resources of the respective Tx pool.

In one or more illustrative examples, assigning each of the plurality of RSUs to a respective Tx pool comprises spatially reusing the Tx pools among the plurality of RSUs that are at least one transmission range apart.

In one or more illustrative examples, the method further includes, for a private cellular vehicle to everything (C-V2X) network, setting a probability of keep parameter for SPS transmissions from the RSUs to ensure persistent use of assigned transmission resources.

In one or more illustrative examples, the method further includes assigning a plurality of transmission slot times to each of the plurality of RSUs, such that the plurality of RSUs are configured to perform reselection to switch from among the plurality of transmission slot times.

In one or more illustrative examples, the method further includes detecting a traffic volume of each of the plurality of RSUs; and adjusting a size of the Tx pool assigned to each of the plurality of RSUs based on the detected traffic volume, such that RSUs with greater traffic volume are assigned greater resources than RSUs with lesser traffic volume.

In one or more illustrative examples, the method further includes detecting a traffic density of each of the plurality of RSUs; and adjusting a size of the Tx pool assigned to each of the plurality of RSUs based on the detected traffic volume, such that RSUs with greater traffic density are assigned greater resources than RSUs with lesser traffic density.

In one or more illustrative examples, a system for partitioning transmit resources for automated vehicle marshaling (AVM) includes a plurality of RSUs configured to communicate with a plurality of vehicles; and an AVM server, configured to assign each RSU of the plurality of RSUs to a non-overlapping RSU transmit (Tx) pool for scheduling such that none of the plurality of RSUs share a common transmission slot within a transmission schedule with another of the plurality of RSUs or with any of the vehicles, assign a common vehicle Tx pool for the plurality of vehicles operating under control of the AVM server, wherein the plurality of vehicles are restricted to transmit within the common vehicle Tx pool to prevent overlapping transmissions with the RSU Tx pools, and transmit, by each of the plurality of RSUs, vehicle control messages using the assigned RSU Tx pool to prevent overlap with transmissions from the other RSUs and/or with the vehicles.

In one or more illustrative examples, the scheduling is semi-persistent scheduling (SPS) and assigning the plurality of Tx pools comprises defining a repeating pattern of time transmission intervals (TTIs) for each of a plurality of different transmission resources of the respective Tx pool.

In one or more illustrative examples, assigning each RSU to a respective Tx pool comprises spatially reusing Tx pools among RSUs that are at least one transmission range apart.

In one or more illustrative examples, the AVM server is further configured to, for a private cellular vehicle-to-everything (C-V2X) network, set a probability of keep parameter for SPS transmissions from the RSUs to ensure persistent use of assigned transmission resources.

In one or more illustrative examples, the AVM server is further configured to assign a plurality of transmission slot times to each of the plurality of RSUs, such that the plurality of RSUs are configured to perform reselection to switch from among the plurality of transmission slot times.

In one or more illustrative examples, the AVM server is further configured to detect a traffic volume of each RSU; and adjust a size of the Tx pool assigned to each of the plurality of RSUs based on the detected traffic volume, such that RSUs with greater traffic volume are assigned greater resources than RSUs with lesser traffic volume.

In one or more illustrative examples, the AVM server is further configured to detect a traffic density of each of the plurality of RSUs; and adjust a size of the Tx pool assigned to each of the plurality of RSUs based on the detected traffic volume, such that RSUs with greater traffic density are assigned greater resources than RSUs with lesser traffic density.

In one or more illustrative examples, a non-transitory computer-readable medium includes instructions for partitioning transmit resources in an automated vehicle marshaling (AVM) system that, when executed by one or more processors of an AVM server in communication with a plurality of RSUs configured to communicate with a plurality of vehicles, cause the AVM server to perform operations including to assign each RSU of the plurality of RSUs to a non-overlapping RSU transmit (Tx) pool for scheduling such that none of the plurality of RSUs share a common transmission slot within a transmission schedule with another RSU or with any of the vehicles; assign a common vehicle Tx pool for vehicles operating in the AVM system, wherein the vehicles are restricted to transmit within the common vehicle Tx pool to prevent overlapping transmissions with the RSU Tx pools; transmit, by each of the plurality of RSUs, vehicle control messages using the assigned RSU Tx pool to prevent overlap with transmissions from the other RSUs and/or with the vehicles.

In one or more illustrative examples, the scheduling is semi-persistent scheduling (SPS) and assigning the plurality of Tx pools comprises defining a repeating pattern of time transmission intervals (TTIs) for each of a plurality of different transmission resources of the respective Tx pool.

In one or more illustrative examples, assigning each of the plurality of RSUs to a respective Tx pool comprises spatially reusing Tx pools among RSUs that are at least one transmission range apart.

In one or more illustrative examples, the non-transitory computer-readable medium further includes instructions that, when executed by the one or more processors of the AVM server, cause the AVM server to perform operations including, for a private C-V2X network, to set a probability of keep parameter for SPS transmissions from the RSUs to ensure persistent use of assigned transmission resources.

In one or more illustrative examples, the non-transitory computer-readable medium further includes instructions that, when executed by the one or more processors of the AVM server, cause the AVM server to perform operations including to assign a plurality of transmission slot times to each of the plurality of RSUs, such that the plurality of RSUs are configured to perform reselection to switch from among the plurality of transmission slot times.

In one or more illustrative examples, the non-transitory computer-readable medium further includes instructions that, when executed by the one or more processors of the AVM server, cause the AVM server to perform operations including one or more of detect a traffic volume of each of the plurality of RSUs and adjust a size of the Tx pool assigned to each of the plurality of RSUs based on the detected traffic volume, such that RSUs with greater traffic volume are assigned greater resources than RSUs with lesser traffic volume; or detect a traffic density of each of the plurality of RSUs and adjust a size of the Tx pool assigned to each of the plurality of RSUs based on the detected traffic volume, such that RSUs with greater traffic density are assigned greater resources than RSUs with lesser traffic density.

### BRIEF DESCRIPTION OF THE DRAWINGS

FIG. 1 illustrates an example system configured for use in partitioning transmit resources into non-overlapping Tx pools;

FIG. 2 illustrates an example environment including a plurality of RSUs and a plurality of vehicles, illustrating a packet loss scenario;

FIG. 3 illustrates an example environment including a plurality of RSUs and a plurality of vehicles, illustrating Tx pools;

FIG. 4 illustrates an example environment including a plurality of RSUs and a plurality of vehicles, illustrating details of an example pool configuration;

FIG. 5 illustrates an example alternate transmission schedule, including a plurality of RSUs and a plurality of vehicles, illustrating multiple available resources for the RSUs for reallocation;

FIG. 6 illustrates an example of spatial reuse of Tx pools across multiple geographically distinct RSUs;

FIG. 7 illustrates an example process for partitioning transmit resources into non-overlapping Tx pools; and

FIG. 8 illustrates an example computing device supporting the partitioning transmit resources into non-overlapping Tx pools.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Marshalling refers to the remote control of vehicles by commands generated by a server and transmitted to the vehicle over a wireless channel, including the C-V2X channel. C-V2X, or short-range V2I communication, is one of the options for AVM wireless communication technology. These marshalling messages may be transmitted through C-V2X infrastructure such as stationary RSUs.

The number of vehicles to be simultaneously controlled could be in the hundreds. To address this, multiple RSUs may be used to convey the control messages from the AVM server to the marshalled vehicles (MVs). While transmitting vehicle control messages via multiple RSUs alleviates the potential overloading of a single RSU, congestion may be compounded by the introduction of the additional RSU devices. Because the C-V2X protocol is based on energy sensing and implicit reservations, packet overlap is possible. For instance, packets sent by one RSU can be sent at the same time as with packets sent by a vehicle and/or as packets sent by another RSU.

There may be stringent requirements on packet loss between the AVM server and the vehicle. In an example, if two or more consecutive packets are lost, the MV may be required to stop. This is referred to as stalling. If the multiple RSUs and the MVs follow the standard C-V2X protocol, this packet loss may occur often enough on the factory floor to cause persistent vehicle stalling.

Aspects of the disclosure utilize C-V2X features to partition the transmit resources of each RSU into non-overlapping Tx pools. The vehicles, in turn, are configured to transmit their packets destined to the AVM server using a common vehicle Tx pool.

In one approach, a probability of keep parameter may be extended from a range of [0, …, 0.8] to include a value of 1.0 in private C-V2X networks. This value may allow a particular semi-persistent scheduling (SPS) flow to continue using the same resources until higher layers revoke this flow. The change in the value of the probability of keep parameter would not affect the functioning of the public C-V2X networks since AVM networks are proposed as private networks. In another approach, the probability of keep parameter is not adjusted and instead redundant resources are assigned to the RSUs to allow for limited reselection. Further aspects of the disclosure are discussed in detail herein.

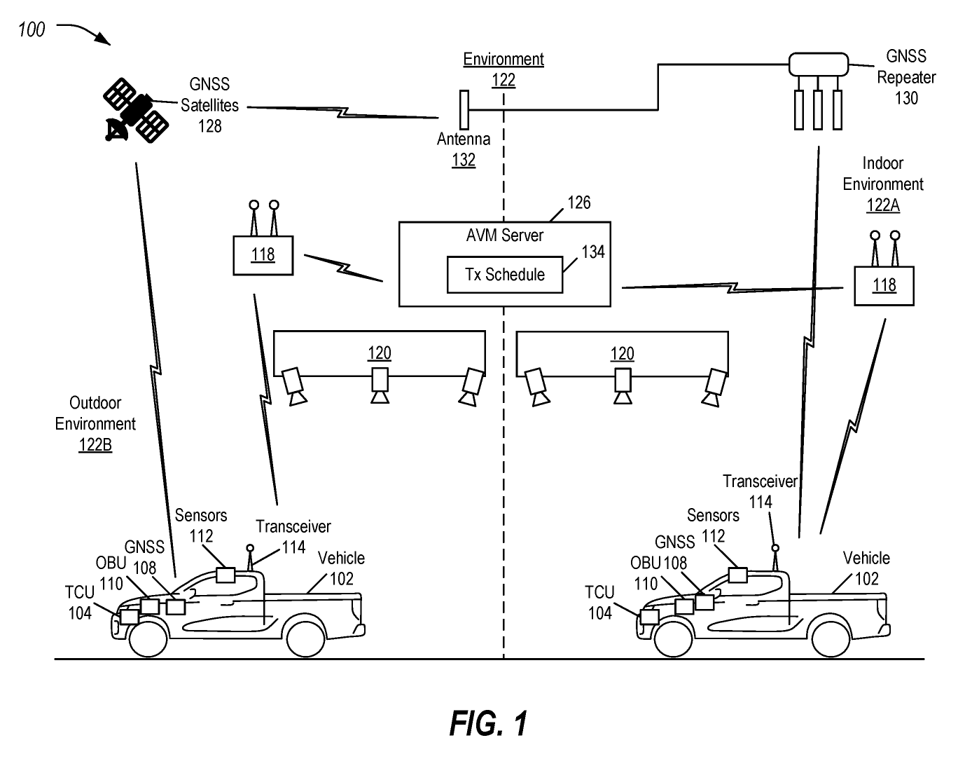

FIG. 1 illustrates an example system 100 configured for use in partitioning transmit resources into non-overlapping Tx pools. The system 100 includes vehicles 102 that may be located in an indoor environment 122A as well as an outdoor environment 122B (collectively environment 122). Each vehicle 102 may include various controllers, such as a telematics control unit (TCU) 104, a global navigation satellite system (GNSS) controller 108, and an OBU 110. The vehicles 102 may also include various vehicle sensors 112. These components of the vehicle 102 may communicate over one or more buses (e.g., vehicle controller area networks (CAN), Ethernet networks, media-oriented system transfer (MOST) networks, wireless networks, etc.), which may allow the OBU 110 to receive data descriptive of the operation of the vehicle 102 components. The system 100 may also include various RSUs 118 in communication with the vehicle 102. The system 100 may include additional components in communication with the vehicles 102 and RSUs 118, such as an AVM server 126. It should be noted that the components of the system 100 are merely an example. Other systems 100 may include more, fewer, or differently located components.

The vehicle 102 may include various other types of passenger vehicles, such as sedans, crossover utility vehicles (CUVs), vans, sport utility vehicles (SUVs), trucks, recreational vehicles (RVs), scooters, or other mobile machines for transporting people or goods. In many cases, the vehicle 102 may be powered by an internal combustion engine. In such cases, the fuel source may be gasoline or diesel fuel. As another possibility, the vehicle 102 may be a hybrid electric vehicle (HEV) powered by both an internal combustion engine and one or more electric motors, such as a series hybrid electric vehicle, a parallel hybrid electric vehicle, or a parallel/series hybrid electric vehicle. As yet a further possibility, the vehicle 102 may be an electric vehicle (EV) powered by electric motors without an internal combustion engine. As the type and configuration of vehicles 102 may vary, the capabilities of the vehicles 102 may correspondingly vary. As some other possibilities, vehicles 102 may have different capabilities with respect to passenger capacity, towing ability and capacity, and storage volume. For title, inventory, and other purposes, the vehicle 102 may be associated with a unique identifier, such as a vehicle identification number (VIN).

The TCU 104 may include network hardware configured to facilitate communication between the vehicle 102 and with other devices of the system 100. The TCU 104 may include various types of computing apparatus in support of performance of the functions of the TCU 104 described herein. In an example, the TCU 104 may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, the processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, JAVA, C, C++, C#, FORTRAN, PASCAL, VISUAL BASIC, PYTHON, JAVASCRIPT, PERL, etc.

The GNSS controller 108 may allow the vehicle 102 to implement autonomous geo-spatial positioning for the vehicle 102. As some examples, the GNSS controller 108 functionality may allow the vehicle 102 to determine its position using one or more satellite networks, such as global positioning system (GPS), GLONASS, Galileo, Beidou and/or others.

The OBU 110 may be configured to provide telematics services to the vehicle 102. These services may include, as some non-limiting possibilities, navigation, turn-by-turn directions, vehicle health reports, local business search, accident reporting, and hands-free calling. The OBU 110 may be in communication with a transceiver 114. The OBU 110 may accordingly be configured to utilize the transceiver 114 to communicate over a cellular network over various protocols. For instance, the OBU 110 may access the cellular network via connection to one or more cellular towers. To facilitate the communications over the communications network, the OBU 110 may be associated with unique device identifiers (e.g., mobile device numbers (MDNs), Internet protocol (IP) addresses, etc.) to identify the communications of the OBU 110 on the communications network as being associated with the vehicle 102. The OBU 110 may, additionally, be configured to communicate over a broadcast peer-to-peer protocol (such as PC5), to facilitate V2X communications with devices such as the RSU 118. It should be noted that these protocols are merely examples, and different peer-to-peer and/or cellular technologies may be used.

The vehicle sensors 112 may be configured to receive information with respect to the surroundings of the vehicle 102. In an example, these vehicle sensors 112 may include one or more of cameras (e.g., advanced driver assistance system (ADAS) cameras), ultrasonic sensors, radio detection and ranging (RADAR) systems, and/or light detection and ranging (LIDAR) systems.

The transceiver 114 may be configured to provide wireless communications services to the TCU 104. The TCU 104 may include or otherwise access a transceiver 114 configured to facilitate communication with other networked devices such as telematics servers or with other vehicles 102. The TCU 104 may be further configured to communicate over various other protocols, such as with a communication network over a network protocol (such as Uu). It should be noted that these protocols are merely examples, and different peer-to-peer and/or cellular technologies may be used.

The RSU 118 may be a device with processing capabilities and networking capabilities and may be designed to be placed in proximity of a roadway for use in communicating with vehicles 102. In an example, the RSU 118 may include hardware configured to communicate over the broadcast peer-to-peer protocol (such as PC5), to facilitate V2X communications with the vehicles 102. The RSU 118 may also have wired or wireless backhaul capability to allow for wired or wireless communication with other elements of the system 100.

The infrastructure sensors 120 may include various devices such as red light cameras, wireless toll gantries, parking meters, under-road traffic counter loops, etc., that use cameras, LIDAR, RADAR, electromagnetism, wireless backscatter, etc., to track the locations or other attributes of vehicles 102, pedestrians, or other traffic participants or obstructions.

The indoor environment 122A may include, for example, factories, dealerships, service centers, parking garages, etc. The outdoor environment 122B may include, for example, a parking lot outside the indoor environment 122A, a roadway, or off-road trails. In the indoor environment 122, the communications between the vehicles 102 and the RSUs 118 may be maintained in a private C-V2X network. This may allow for greater control as compared to the outdoor environment 122B where it may be difficult to ensure a closed private network.

The AVM server 126 may be configured to monitor the vehicles 102, whether the vehicles 102 are in the indoor environment 122A or the outdoor environment 122B. The AVM server 126 may be configured to use wireless networks to control and monitor the vehicles 102 (e.g., as MVs). The AVM server 126 may communicate with the vehicles 102 using the RSUs 118, which may be placed at strategic locations, such as intersections, docking bays, and high-traffic zones. This allows the AVM server 126 to relay information to the vehicles 102 such as navigation instructions, route optimization, object alerts, and updates on the operational status of machinery or other moving assets.

The AVM server 126 may be configured to perform GNSS-based location services for locating the vehicles 102, including providing a map of the locations of a plurality of vehicles 102 on a map. The AVM server 126 may also be configured to receive sensor data from the infrastructure sensors 120, to form a more complete view of the status of each of the vehicles 102 in addition to their locations.

When operating in the outdoor environment 122B, the AVM server 126 may be configured to make use of a constellation of GNSS satellites 128 to facilitate the geolocation of the vehicles 102. This may be accomplished, for example, via the vehicles 102 using their GNSS controller 108 to locate themselves using the GNSS satellites 128 and sending that location information wirelessly via their OBUs 110 and transceivers 114 to RSUs 118 which are in communication with the AVM server 126.

When operating in the indoor environment 122A, however, the vehicles 102 may make use of signals from GNSS repeaters 130. The GNSS repeaters 130 may receive signals from the constellation of GNSS satellites 128 via antennas 132 that are located within line of sight to the GNSS satellites 128. The GNSS repeaters 130 may use the antennas 132 to capture GNSS broadcasts and may rebroadcast those signals into the indoor environment 122A. This allows the vehicles 102 to make use of location services when inside, that may not otherwise be possible due the constellation of GNSS satellites 128 not being visible by the vehicles 102 when they are located in the indoor environment 122A. However, the repeater approach may reduce accuracy of the GNSS location when in the indoor environment 122A. It should be noted that this is only an example, and other location technologies may additionally or alternately be used, such as ultra-wideband (UWB) for high-precision real-time location systems (RTLS) for tracking the vehicles 102 in the indoor environment 122A.

An additional use of the GNSS satellites 128 and GNSS repeaters 130 is for use in precise timing which can be used to synchronize the over-the-air C-V2X transmissions. In the absence of GNSS repeaters 130 in the indoor environment the C-V2X over-the-air interface may provide a feature which allows the RSUs 118 in the indoor environment 122A to provide synchronization with the RSUs 118 in the outdoor environment 122B. This may be achieved if the RSUs 118 of the outdoor environment 122B can receive the GNSS signal from the satellites directly and become synchronized. Once the RSUs 118 of the indoor environment 122A are synchronized with at least one RSU 118 of the outdoor environment 122B, the RSUs 118 may provide the synchronization signal over-the-air to the attached vehicle OBUs 108. The vehicle 102 may switch between the RSUs 118 of the indoor environment 122A as a synchronization source to the GNSS satellite 128 as it moves from the indoor environment 122A to the outdoor environment 122B and vice versa.

The AVM server 126 may be configured to request initiation of a semi-persistent scheduling (SPS) transmission schedule 134 for communication between the vehicles 102 and the RSUs 118. SPS is a resource allocation technique used in wireless networks, such as in C-V2X and 5G-based communications, where the AVM server 126 pre-assigns communication resources to vehicles 102 and RSUs 118 at periodic intervals, reducing the overhead of frequent scheduling requests. While the AVM server 126 can request a new SPS to be initiated, the selection of radio resources and maintenance of regular transmissions based on the SPS parameters are managed by the RSUs 118. In an indoor environment 122B, the AVM server 126 can define SPS parameters to ensure that control messages are transmitted at consistent, predefined intervals between the RSUs 118 and the OBUs 110 on the vehicles 102. This approach minimizes latency, optimizes spectral efficiency, and enhances reliability, which is helpful for control of the MVs. Examples of the SPS transmission schedule 134 are discussed in detail herein.

SPS operates by reserving specific time-frequency radio resources for periodic transmission, eliminating the need for vehicles 102 or RSUs 118 to request scheduling grants for each transmission. Once an SPS configuration is established, the RSU 118 allocates a set of transmission opportunities to an OBU 110 at predefined intervals, ensuring predictable and low-latency communication. The SPS parameters may define the periodicity of transmissions, the specific physical resource blocks (PRBs) allocated, and the modulation and coding scheme (MCS) used for communication. If a vehicle 102 or RSU 118 detects a need to modify its SPS allocation, such as adjusting for network congestion or adapting to dynamic radio conditions, the vehicle 102 or RSU 118 may trigger a request to reconfigure the SPS parameters. Additionally, SPS may incorporate a semi-adaptive mechanism where transmissions occur persistently unless a release or reallocation request is received. This scheduling technique is particularly advantageous in high-reliability applications such as vehicle control and cooperative maneuvering, as it reduces the overhead associated with dynamic resource allocation while ensuring timely message delivery.

While SPS-based transmissions are a preferred way of scheduling transmission, in some cases (such as reaching the maximum allowed number of SPS flows) it may be necessary to send transmissions in a non-SPS manner, sometimes referred to as event-based (or one-shot) transmissions. These event-based transmissions can also be sent over the same Tx pool defined for a particular RSU 118.

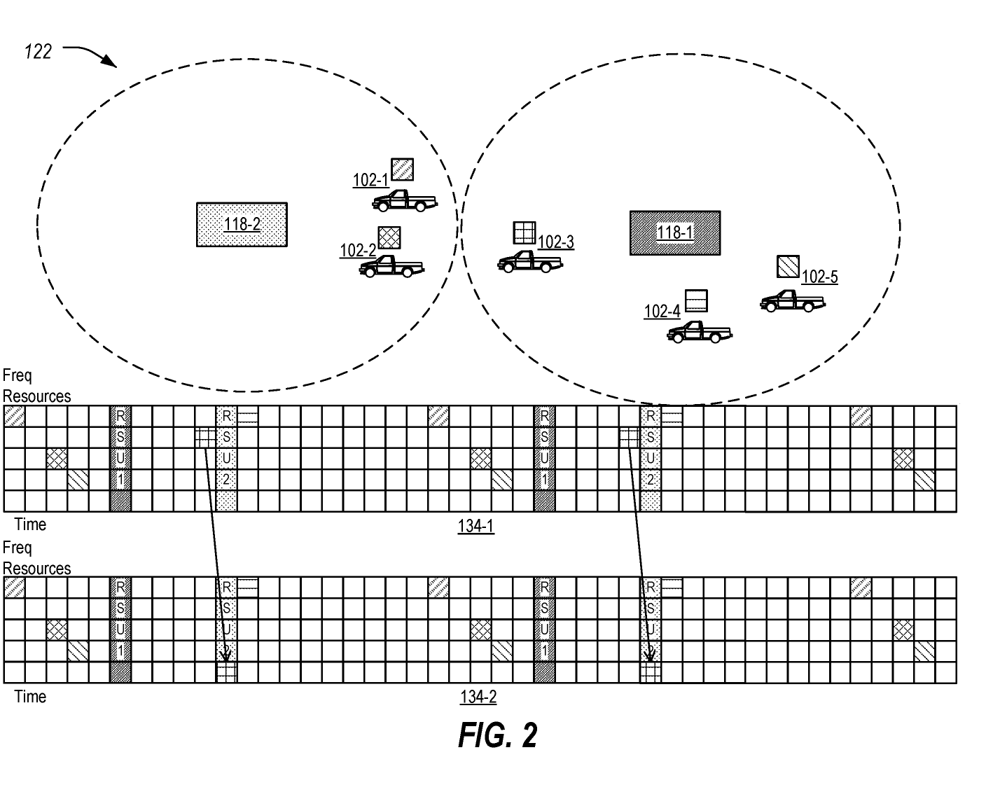

FIG. 2 illustrates an example environment 122 including a plurality of RSUs 118 and a plurality of vehicles 102, illustrating a packet loss scenario. As shown the plurality of RSUs 118 includes RSU 118-1 and RSU 118-2. The plurality of vehicles 102 includes vehicles 102-1, 102-2, 102-3, 102-4, and 102-5. Additionally, two SPS transmission schedules 134 are shown, a first SPS transmission schedule 134-1 and a second SPS transmission schedule 134-2. The vertical axis of the SPS transmission schedules 134 represents different transmission resources in the frequency domain, while the horizontal axis represents time. Each of the vehicles 102 and RSUs 118 is associated with a different pattern, where these patterns are used to indicate the resources and timing of the packets sent by the respective vehicles 102 and RSUs 118. Moreover, the vehicles 102-1 and 102-2 are within the transmission area of the RSU 118-2, while the vehicles 102-3, 102-4, and 102-5 are within the transmission area of the RSU 118-1.

In the SPS transmission schedule 134-1, the RSU 118-1 sends periodic transmissions across all resources, here shown during time indexes eleven and thirty-one. Similarly, the RSU 118-2 sends periodic transmissions across all resources during time indexes six and twenty-six.

For illustration purposes, the vehicle 102-1 sends periodic transmissions using the first resource block during the first, twenty-first, and forty-first time indexes. The vehicle 102-2 sends periodic transmissions using the third resource block during the third, twenty-third, and forty-third time indexes. The vehicle 102-3 sends periodic transmissions using the second resource block, during the tenth and thirtieth time indexes. The vehicle 102-4 sends periodic transmissions using the first resource block in the twelfth and thirty-second time indexes. The vehicle 102-5 sends periodic transmissions using the fourth resource block during the fourth, twenty-fourth, and forty-fourth time indexes.

In the SPS transmission schedule 134-2, the vehicle 102-3 has reselected resources. This reselection may occur from time to time by the various devices of the system 100 according to the C-V2X multi-access protocol. After reselection, in the SPS transmission schedule 134-2, all transmissions are the same, except that now the vehicle 102-3 is instead transmitting using the fifth resource block and one time index later, here during the eleven and thirty-one time indexes.

In the SPS transmission schedule 134-1, there are no overlapping transmissions. Thus, it is likely that all packets will be able to be received to their destinations. However, in the SPS transmission schedule 134-2, the transmissions of the vehicle 102-3 overlap those of the RSU 118-2. This may cause the packets destined to the vehicles 102 that are served by the RSU 118-2 (e.g., to vehicles 102-1 and 102-2) to be lost. Moreover, because the pattern is persistent, multiple consecutive packets may be lost, causing the vehicles 102-1 and 102-2 to stall.

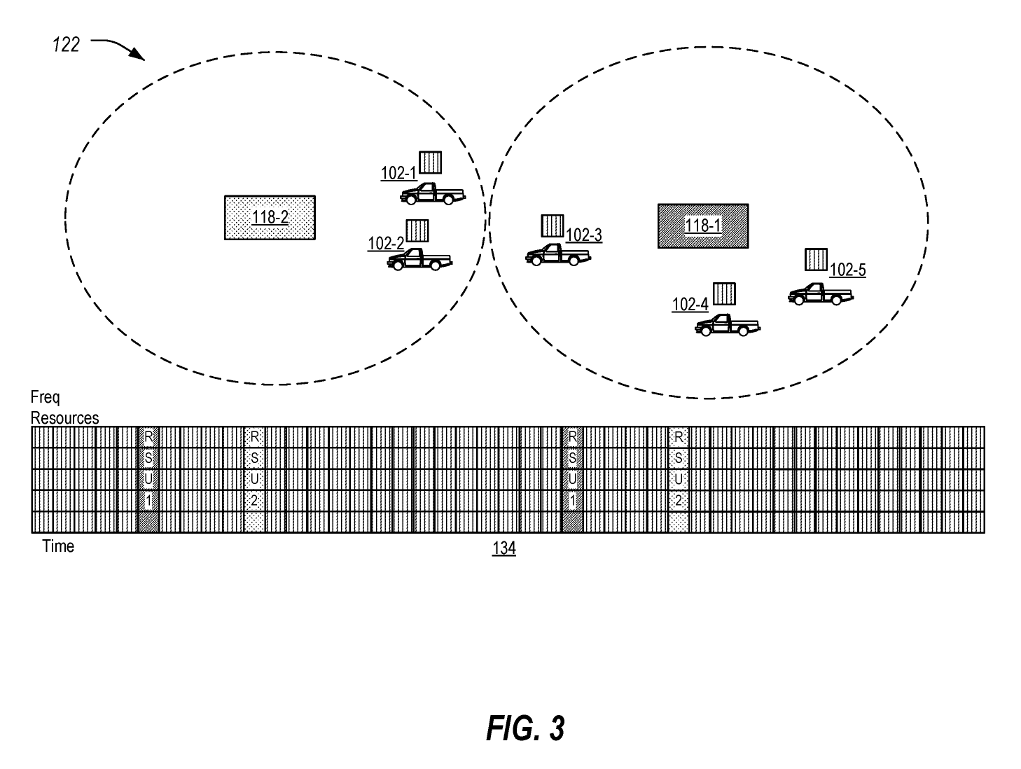

FIG. 3 illustrates an example environment 122 including a plurality of RSUs 118 and a plurality of vehicles 102, illustrating Tx pools. As shown, in the SPS transmission schedule 134, the transmit resources for the RSU 118-1 are configured such that the set of resources for the RSU 118-1 are dedicated only for use by the RSU 118-1. Similarly, the transmit resources for the RSU 118-2 are configured such that the set of resources for the RSU 118-2 are dedicated only for use by the RSU 118-2. The remaining transmit resources are dedicated for use by the OBUs 110 of the vehicles 102, such that the vehicles 102 may only use those resources. Using such an approach, the vehicles 102 will not produce transmissions that overlap the transmissions of the RSUs 118.

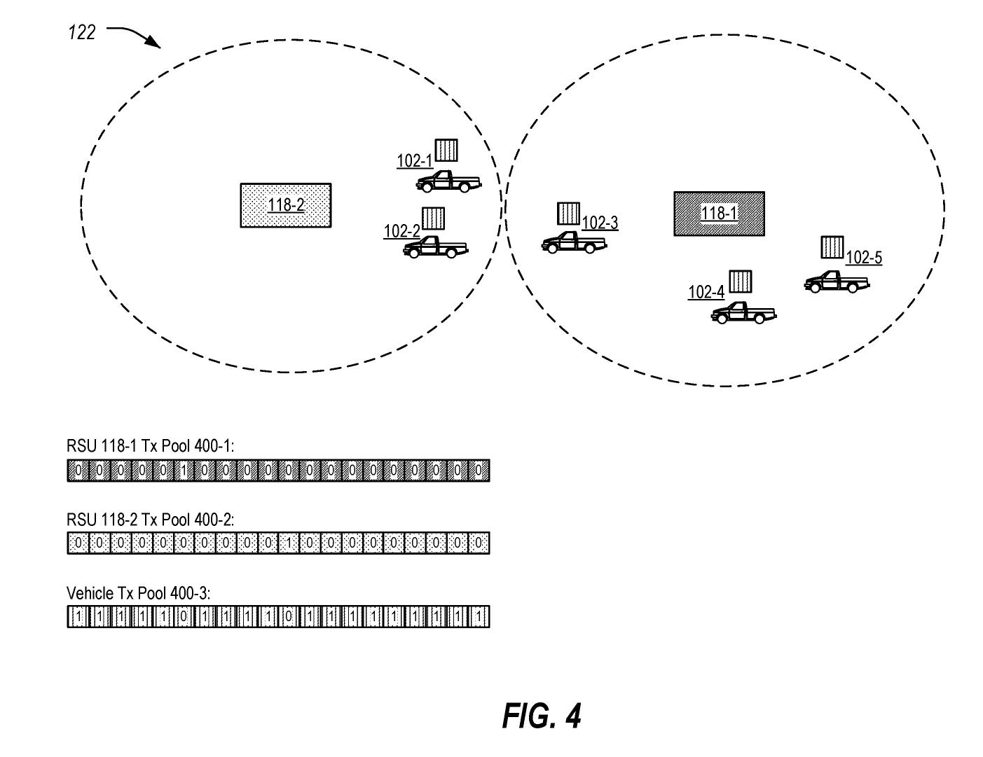

FIG. 4 illustrates an example environment 122 including a plurality of RSUs 118 and a plurality of vehicles 102, illustrating details of an example pool configuration. As shown, the Tx pools for the RSU 118-1, the RSU 118-2, and the vehicle OBUs 110 are configured using bitmaps 400 indicating which slots, referred to as time transmission intervals (TTIs), are allowed for transmission. The bitmaps 400 for the Tx pools describe a specific period which is then repeating. In the illustrated case, the period is 20 TTIs, but that is only an example and bitmaps 400 of different lengths may specify shorter or longer patterns for the Tx pools.

As shown the RSU 118-1 is allocated the sixth slot while the RSU 118-2 is allocated the eleventh slot. The vehicles 102 are then allocated the remaining slots, e.g., all slots except for the sixth and eleventh slots. It should be noted that this is only an example, and different examples with more RSUs 118 or different slot allocations may be used.

Given that the transmissions of the RSUs 118-1 and 118-2 do not overlap, and that the OBU 110 transmissions of the vehicles 102 do not overlap with either RSU 118-1 or RSU 118-2 transmissions, the packets transmitted by either RSU 118-1 or RSU 118-2 will not experience overlap. It should be noted that packets transmitted by the vehicles 102 may still potentially interfere among themselves, but this effect is not any worse than without the Tx pools allocated to the RSUs 118, and in any event the requirement on packet loss for the vehicle packets is not as stringent as the packet loss for the packets of the AVM server 126.

In such an approach, only one set of resources has been assigned to each of the RSUs 118. This is the minimum allocation that may be used for each RSU 118. However, at the time of reselection the probability that the scheduler will decide to find a different set of resources. This may create an issue because there is only one possible resource choice for each RSU 118.

One approach to addressing this is that for a private C-V2X network provided by the AVM server 126, the probability of keep for the SPS flows of the RSUs 118 may be set to 1. This means that the allocation of resources will always be kept and not be altered. This accordingly allows the RSUs 118 to continue sending on the same set of resources assigned through the Tx pool.

A similar extension may be introduced if, instead of SPS flows, the packets from the RSU 118 are sent as event-based transmissions. In such an option, the AVM server 126 may be reconfigured to allow the transmissions to always use the same resources.

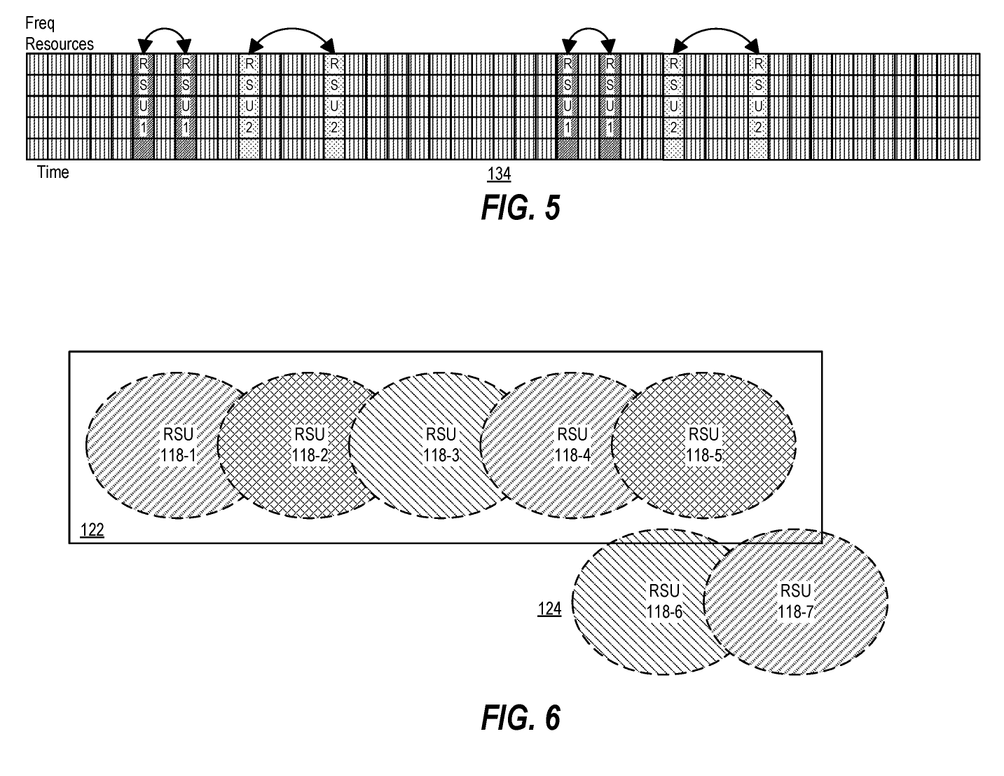

FIG. 5 illustrates an example alternate SPS transmission schedule 134, including a plurality of RSUs 118 and a plurality of vehicles 102, illustrating multiple available resources for the RSUs 118 for reallocation. FIG. 5 shows a third alternative to those discussed above, which may be less optimal in that it allocates double the needed resources to each RSU 118. In this approach, the RSUs 118 can toggle between the different resources at the time of reselection. While less optimal, this solution would still guarantee no packet loss for the packets of the AVM server 126 sent by the RSU 118 to the vehicles 102.

FIG. 6 illustrates an example of spatial reuse of Tx pools across multiple geographically distinct RSUs 118. As shown, five RSUs 118-1, 118-2, 118-3, 118-4, and 118-5 are arranged from one side of the indoor environment 122A to the other side of the indoor environment 122A in a single line array. Two additional RSUs 118-6, 118-7 are arranged in the outdoor environment 122B outside of the indoor environment 122A.

Due to the distances between the RSUs 118, RSUs 118 that are relatively far from one another, e.g., at least one transmission range away, may be able to reuse the same allocated Tx pools. As shown, the RSUs 118-1, 118-4, and 118-7 each use the same first Tx pool, the RSUs 118-2, 118-5 use the same second Tx pool, and the RSUs 118-3, 118-6 use the same third Tx pool. Other combinations of reuse are also possible.

Variations on the disclosed concepts are possible. In an example, the Tx pool configuration may be monitored and adjusted over time by the AVM server 126 which monitors overall traffic (e.g., using static vs. dynamic pool assignment). In another example, an RSU 118 that sees a larger traffic volume may be assigned a larger Tx pool than an RSU 118 that sees a smaller traffic volume.

Another variation can be achieved in the case when the total number of resources are not divisible by the number of resources per RSU 118. In the example shown in FIG. 6 it is assumed that six TTIs are assigned in groups of two; thus, each RSU 118 is assigned either resources (1, 2), (3, 4), or (5, 6). If the total number of resources is for example seven, and the number of resources assigned per RSU 118 is still two, then a spatial pattern of assignments may for example be (1, 2), (3, 4), (5, 6), (7, 1), and (2, 3), for RSUs 118-1, 118-2, 118-3, 118-4 and 118-5, respectively.

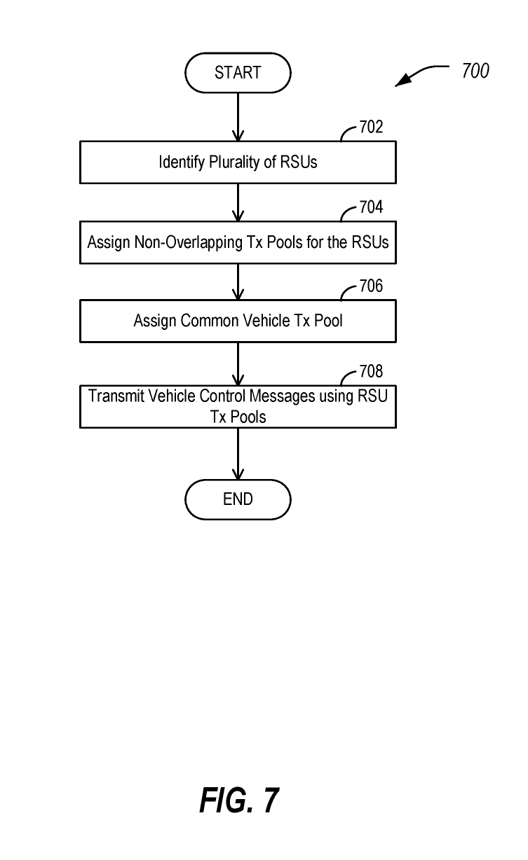

FIG. 7 illustrates an example process 700 for partitioning transmit resources into non-overlapping Tx pools. In an example, the process 700 may be performed by the AVM server 126 in the context of the system 100. The goal of the spatial partitioning of the Tx resources between various RSUs 118 is to allocate minimum sufficient resources to each RSU 118, thus leaving as many resources as possible for the vehicle OBU 110 transmissions. The allocation of resources to each RSU 118 should therefore take into account the traffic load of that RSU 118 which may vary with time. Thus, the allocation of Tx pools for RSUs 118 may take this fluctuation into account. Allocation of resources for the purpose of resource reselection is also part of this operation. An example of a Tx pool assignment with seven resources as shown above for a non-uniform traffic load where RSU 118-2 has higher load than its neighbors could look as follows: (1, 2), (3, 4, 5), (6), (7, 1), (2, 3) for RSUs 118-1, 118-2, 118-3, 118-4 and 118-5, respectively.

Yet another option of configuring radio resources for the use by RSUs 118 may be to allow wider sharing of some resources to increase flexibility and potentially for carrying lower priority traffic. For example, some radio resources could be assigned to RSUs 118 that are close enough that they could potentially cause interference with one another. In another example, these shared radio resources could also be part of the vehicle Tx pool.

In addition to an allocation in the case of non-uniform load and/or an allocation performing wider sharing of resources among the RSUs 118 for lower priority traffic, the allocation may also account for traffic and density of vehicles 102 in bottleneck pathways. For example, the AVM server 126 may be programmed to understand that certain RSUs 118 control areas of higher traffic density. In other examples, the AVM server 126 may monitor the locations of the vehicles 102 (e.g., via the RSUs 118) to determine the locations of the vehicles 102 and therefore the areas of higher density. For a higher density situation, the allocation may provide more resources to those vehicles 102 passing those higher density areas. This may be done to address the potential for vehicles 102 traversing narrow pathways to have a greater chance to block the vehicular traffic behind.

At operation 702, the AVM server 126 identifies a plurality of RSUs 118 of the system 100. In an example, the AVM server 126 may access or identify a configuration of the RSUs 118, including RSUs 118 that are located in the indoor environment 122 as well as RSUs 118 located in the outdoor environment 122B.

At operation 704, the AVM server 126 assigns each RSU 118 of the plurality of RSUs 118 to a non-overlapping RSU Tx pool for SPS. This assignment may be performed such that no RSUs 118 share a common transmission slot within the transmission schedule with another RSU 118 or with any of the vehicles 102. The assigning of the plurality of Tx pools may include defining a repeating pattern of TTIs for each of a plurality of different transmission resources of the respective Tx pool. The assigning each RSU to a respective Tx pool comprises spatially reusing Tx pools among RSUs that are at least N RSU coverage area radii apart, where N can be various values such as four.

In some examples, for a private C-V2X network, the assigning may include setting a probability of keep parameter for SPS transmissions from the RSUs 118 to ensure persistent use of assigned transmission resources. In other examples, the assigning may include assigning a plurality of transmission slot times to each of the plurality of RSUs 118, such that the plurality of RSUs 118 are configured to perform reselection to switch from among the plurality of transmission slot times. In some examples, the assigning may include detecting a traffic volume of each RSU 118; and adjusting a size of the Tx pool assigned to each RSU 118 based on the detected traffic volume.

At operation 706, the AVM server 126 assigning a common vehicle Tx pool for vehicles 102 operating in the system 100. Accordingly, the vehicles 102 are restricted to transmit within the common vehicle 102 Tx pool to prevent overlapping transmissions with the RSU 118 Tx pools.

At operation 708, the AVM server 126 causes the RSUs 118 to transmit vehicle 102 control messages using the assigned RSU 118 Tx pools. By having the RSUs 118 utilize their assigned resources, the system 100 may prevent concurrent packet issues with transmissions from the other RSUs 118 and/or with the vehicles 102. After operation 708, the process 700 ends.

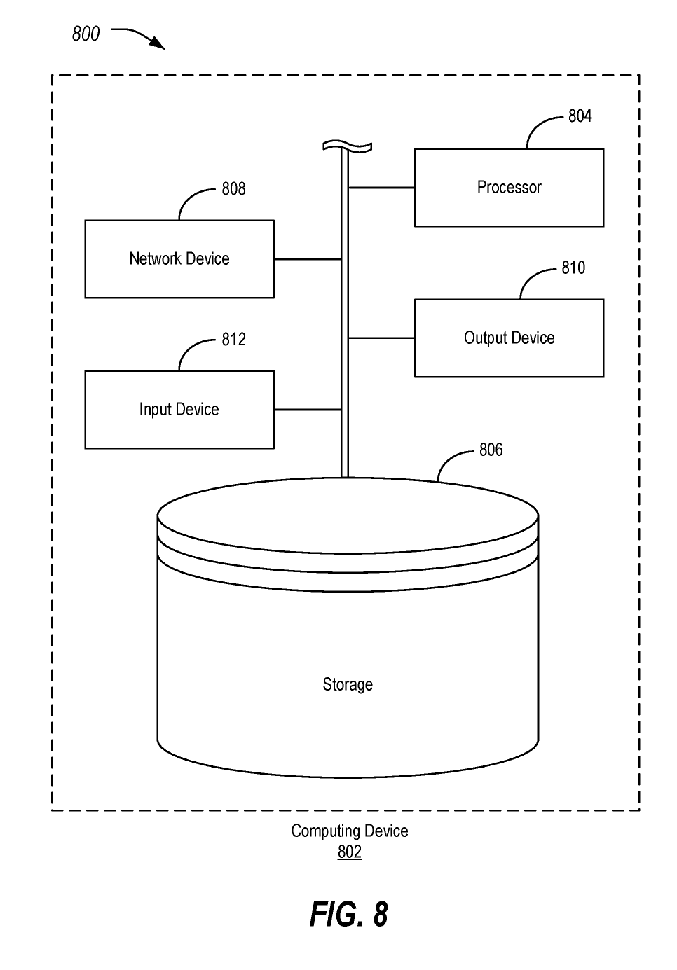

FIG. 8 illustrates an example computing device supporting the partitioning transmit resources into non-overlapping Tx pools. Referring to FIG. 8, and with reference to FIGS. 1-7, the vehicles 102, TCUs 104, GNSS controllers 108, OBUs 110, vehicle sensors 112, transceivers 114, RSUs 118, AVM servers 106, GNSS satellites 128, GNSS repeaters 130, etc., may be examples of such computing devices 802. Computing devices 802 generally include computer-executable instructions, where the instructions may be executable by one or more computing devices 802. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

As shown, the computing device 802 may include a processor 804 that is operatively connected to a storage 806, a network device 808, an output device 810, and an input device 812. It should be noted that this is merely an example, and computing devices 802 with more, fewer, or different components may be used.

The processor 804 may include one or more integrated circuits that implement the functionality of a central processing unit (CPU) and/or graphics processing unit (GPU). In some examples, the processors 804 are a system on a chip (SoC) that integrates the functionality of the CPU and GPU. The SoC may optionally include other components such as, for example, the storage 806 and the network device 808 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 804 executes stored program instructions that are retrieved from the storage 806. The stored program instructions, accordingly, include software that controls the operation of the processors 804 to perform the operations described herein. The storage 806 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 810. The output device 810 may include a graphical or visual display device, such as an electronic display screen, projector, printer, or any other suitable device that reproduces a graphical display. As another example, the output device 810 may include an audio device, such as a loudspeaker or headphone. As yet a further example, the output device 810 may include a tactile device, such as a mechanically raiseable device that may, in an example, be configured to display braille or another physical output that may be touched to provide information to a user.

The input device 812 may include any of various devices that enable the computing device 802 to receive control input from users. Examples of suitable input devices 812 that receive human interface inputs may include keyboards, mice, trackballs, touchscreens, microphones, graphics tablets, and the like.

The network devices 808 may each include any of various devices that enable the described components to send and/or receive data from external devices over networks. Examples of suitable network devices 808 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as "a," "the," "said," etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for partitioning transmit resources in an automated vehicle marshaling (AVM) system, the method comprising:
identifying a plurality of road-side units (RSUs) of the AVM system, the RSUs configured to communicate with a plurality of vehicles;
assigning each RSU of the plurality of RSUs to a non-overlapping RSU transmit (Tx) pool for scheduling such that none of the RSUs share a common transmission slot within a transmission schedule with another RSU or with any of the vehicles;
assigning a common vehicle Tx pool for the vehicles, wherein the vehicles are restricted to transmit within the common vehicle Tx pool to prevent overlapping transmissions with the RSU Tx pools;
transmitting, by each of the plurality of RSUs, vehicle control messages using the assigned RSU Tx pool to prevent overlap with transmissions from the other RSUs and/or with the vehicles.

2. The method of claim 1, wherein the scheduling is semi-persistent scheduling (SPS) and assigning the plurality of Tx pools comprises defining a repeating pattern of time transmission intervals (TTIs) for each of a plurality of different transmission resources of the respective Tx pool.

3. The method of claim 1, wherein assigning each of the plurality of RSUs to a respective Tx pool comprises spatially reusing the Tx pools among the plurality of RSUs that are a plurality of RSU coverage area radii apart.

4. The method of claim 1, further comprising, for a private cellular vehicle to everything (C-V2X) network, setting a probability of keep parameter for SPS transmissions from the RSUs to ensure persistent use of assigned transmission resources.

5. The method of claim 1, further comprising assigning a plurality of transmission slot times to each of the plurality of RSUs, such that the plurality of RSUs are configured to perform reselection to switch from among the plurality of transmission slot times.

6. The method of claim 1, further comprising:
detecting a traffic volume of each of the plurality of RSUs; and
adjusting a size of the Tx pool assigned to each of the plurality of RSUs based on the detected traffic volume, such that RSUs with greater traffic volume are assigned greater resources than RSUs with lesser traffic volume.

7. The method of claim 1, further comprising:
detecting a traffic density of each of the plurality of RSUs; and
adjusting a size of the Tx pool assigned to each of the plurality of RSUs based on the detected traffic volume, such that RSUs with greater traffic density are assigned greater resources than RSUs with lesser traffic density.

8. A system for partitioning transmit resources for automated vehicle marshaling (AVM), the system comprising:
a plurality of RSUs configured to communicate with a plurality of vehicles; and
an AVM server, configured to:
assign each RSU of the plurality of RSUs to a non-overlapping RSU transmit (Tx) pool for scheduling such that none of the plurality of RSUs share a common transmission slot within a transmission schedule with another of the plurality of RSUs or with any of the vehicles,
assign a common vehicle Tx pool for the plurality of vehicles operating under control of the AVM server, wherein the plurality of vehicles are restricted to transmit within the common vehicle Tx pool to prevent overlapping transmissions with the RSU Tx pools, and
transmit, by each of the plurality of RSUs, vehicle control messages using the assigned RSU Tx pool to prevent overlap with transmissions from the other RSUs and/or with the vehicles.

9. The system of claim 8, wherein the scheduling is semi-persistent scheduling (SPS) and assigning the plurality of Tx pools comprises defining a repeating pattern of time transmission intervals (TTIs) for each of a plurality of different transmission resources of the respective Tx pool.

10. The system of claim 8, wherein assigning each RSU to a respective Tx pool comprises spatially reusing Tx pools among RSUs that are at least a plurality of RSU coverage area radii apart.

11. The system of claim 8, wherein the AVM server is further configured to, for a private cellular vehicle-to-everything (C-V2X) network, set a probability of keep parameter for SPS transmissions from the RSUs to ensure persistent use of assigned transmission resources.

12. The system of claim 8, wherein the AVM server is further configured to assign a plurality of transmission slot times to each of the plurality of RSUs, such that the plurality of RSUs are configured to perform reselection to switch from among the plurality of transmission slot times.

13. The system of claim 8, wherein the AVM server is further configured to:
detect a traffic volume of each RSU; and
adjust a size of the Tx pool assigned to each of the plurality of RSUs based on the detected traffic volume, such that RSUs with greater traffic volume are assigned greater resources than RSUs with lesser traffic volume.

14. The system of claim 8, wherein the AVM server is further configured to:
detect a traffic density of each of the plurality of RSUs; and
adjust a size of the Tx pool assigned to each of the plurality of RSUs based on the detected traffic volume, such that RSUs with greater traffic density are assigned greater resources than RSUs with lesser traffic density.

15. A non-transitory computer-readable medium comprising instructions for partitioning transmit resources in an automated vehicle marshaling (AVM) system that, when executed by one or more processors of an AVM server in communication with a plurality of RSUs configured to communicate with a plurality of vehicles, cause the AVM server to perform operations including to:
assign each RSU of the plurality of RSUs to a non-overlapping RSU transmit (Tx) pool for scheduling such that none of the plurality of RSUs share a common transmission slot within a transmission schedule with another RSU or with any of the vehicles;
assign a common vehicle Tx pool for vehicles operating in the AVM system, wherein the vehicles are restricted to transmit within the common vehicle Tx pool to prevent overlapping transmissions with the RSU Tx pools;
transmit, by each of the plurality of RSUs, vehicle control messages using the assigned RSU Tx pool to prevent overlap with transmissions from the other RSUs and/or with the vehicles.

16. The non-transitory computer-readable medium of claim 15, wherein the scheduling is semi-persistent scheduling (SPS) and assigning the plurality of Tx pools comprises defining a repeating pattern of time transmission intervals (TTIs) for each of a plurality of different transmission resources of the respective Tx pool.

17. The non-transitory computer-readable medium of claim 15, wherein assigning each of the plurality of RSUs to a respective Tx pool comprises spatially reusing Tx pools among RSUs that are at least a plurality of RSU coverage area radii apart.

18. The non-transitory computer-readable medium of claim 15, further comprising instructions that, when executed by the one or more processors of the AVM server, cause the AVM server to perform operations including, for a private C-V2X network, to set a probability of keep parameter for SPS transmissions from the RSUs to ensure persistent use of assigned transmission resources.

19. The non-transitory computer-readable medium of claim 15, further comprising instructions that, when executed by the one or more processors of the AVM server, cause the AVM server to perform operations including to assign a plurality of transmission slot times to each of the plurality of RSUs, such that the plurality of RSUs are configured to perform reselection to switch from among the plurality of transmission slot times.

20. The non-transitory computer-readable medium of claim 15, further comprising instructions that, when executed by the one or more processors of the AVM server, cause the AVM server to perform operations including one or more of to:
detect a traffic volume of each of the plurality of RSUs and adjust a size of the Tx pool assigned to each of the plurality of RSUs based on the detected traffic volume, such that RSUs with greater traffic volume are assigned greater resources than RSUs with lesser traffic volume; or
detect a traffic density of each of the plurality of RSUs and adjust a size of the Tx pool assigned to each of the plurality of RSUs based on the detected traffic volume, such that RSUs with greater traffic density are assigned greater resources than RSUs with lesser traffic density.
